(19) United States
(12) Patent Application Publication
(10) Pub. No.: US 2024/0119723 A1
(43) Pub. Date: Apr. 11, 2024

(54) INFORMATION PROCESSING DEVICE, AND SELECTION OUTPUT METHOD

(71) Applicant: Mitsubishi Electric Corporation, Tokyo (JP)

(72) Inventors: Jia QU, Tokyo (JP); Shoichi SHIMIZU, Tokyo (JP)

(73) Assignee: Mitsubishi Electric Corporation, Tokyo (JP)

(21) Appl. No.: 18/273,278

(22) PCT Filed: Feb. 5, 2021
(86) PCT No.: PCT/JP2021/004388

§ 371 Date: Jul. 20, 2023

(51) Int. Cl. G06V 10/70; G06V 10/774; G06V 10/776; G06V 20/70

(52) U.S. Cl. CPC G06V 10/87; G06V 10/7753; G06V 10/776; G06V 20/70

(57) ABSTRACT

An information processing device includes an acquisition unit that acquires learned models for executing object detection by methods different from each other and a plurality of pieces of unlabeled learning data as a plurality of images including an object, an object detection unit that performs the object detection on each of the plurality of pieces of unlabeled learning data by using the learned models, a calculation unit that calculates a plurality of information amount scores indicating values of the plurality of pieces of unlabeled learning data based on a plurality of object detection results, and a selection output unit that selects a predetermined number of pieces of unlabeled learning data from the plurality of pieces of unlabeled learning data based on the plurality of information amount scores and outputs the selected unlabeled learning data.

### TECHNICAL FIELD

The present disclosure relates to an information processing device, a selection output method and a selection output program.

### BACKGROUND ART

In general, to realize excellent performance of a device that uses a learned model, the device executes deep learning by using a great amount of training data (referred to also as a learning data set, for example). For example, when a learned model for detecting an object in an inputted image is generated, the training data includes a region of the object as the detection target in the image and a label indicating the type of the object. The training data is generated by a labeling worker. The generating work executed by the labeling worker is referred to as labeling. The labeling executed by the labeling worker increases the load on the labeling worker. In such a circumstance, active learning has been devised in order to lighten the load on the labeling worker. In the active learning, images labeled and having great learning effect are used as the training data.

Here, a technology for selecting data to be used for the active learning has been proposed (see Patent Reference 1). An active learning device calculates a classification score in regard to unlabeled learning data by using a classifier that has been learned by using labeled learning data. The active learning device generates a plurality of clusters by clustering the unlabeled learning data. The active learning device selects learning data to be used for the active learning from the unlabeled learning data based on the plurality of clusters and the classification score.

### PRIOR ART REFERENCE

### Patent Reference

Patent Reference 1: Japanese Patent Application Publication No. 2017-167834

### SUMMARY OF THE INVENTION

### Problem to be Solved by the Invention

In the above-described technology, the learning data is selected by using a classifier, obtained by executing learning in a certain method by using labeled learning data, and unlabeled learning data. Incidentally, the classifier is hereinafter referred to as a learned model. The selected learning data is learning data having great learning effect when the learning is executed by using the certain method. In contrast, when a learned model using a different method is generated, the selected learning data cannot necessarily be regarded as learning data having great learning effect. Therefore, methods using the above-described technology cannot necessarily be considered to be desirable. Thus, how to select learning data having great learning effect is an important issue.

An object of the present disclosure is to select learning data having great learning effect.

### Means for Solving the Problem

An information processing device according to an aspect of the present disclosure is provided. The information processing device includes an acquisition unit that acquires a plurality of learned models for executing object detection by methods different from each other and a plurality of pieces of unlabeled learning data as a plurality of images including an object, an object detection unit that performs the object detection on each of the plurality of pieces of unlabeled learning data by using the plurality of learned models, a calculation unit that calculates a plurality of information amount scores indicating values of the plurality of pieces of unlabeled learning data based on a plurality of object detection results, and a selection output unit that selects a predetermined number of pieces of unlabeled learning data from the plurality of pieces of unlabeled learning data based on the plurality of information amount scores and outputs the selected unlabeled learning data.

### Effect of the Invention

According to the present disclosure, learning data having great learning effect can be selected.

### BRIEF DESCRIPTION OF THE DRAWINGS

FIG. 1 is a block diagram showing functions of an information processing device in a first embodiment.

FIG. 2 is a diagram showing hardware included in the information processing device in the first embodiment.

FIGS. 3(A) and 3(B) are diagrams for explaining IoU in the first embodiment.

FIG. 4 is a diagram showing a relationship among Precision, Recall and AP in the first embodiment.

FIGS. 5(A) and 5(B) are diagrams (No. 1) showing examples of output of selected images.

FIGS. 6(A) and 6(B) are diagrams (No. 2) showing examples of the output of the selected images.

FIG. 7 is a block diagram showing functions of an information processing device in a second embodiment.

FIG. 8 is a flowchart showing an example of a process executed by the information processing device in the second embodiment.

### MODE FOR CARRYING OUT THE INVENTION

Embodiments will be described below with reference to the drawings. The following embodiments are just examples and a variety of modifications are possible within the scope of the present disclosure.

### First Embodiment

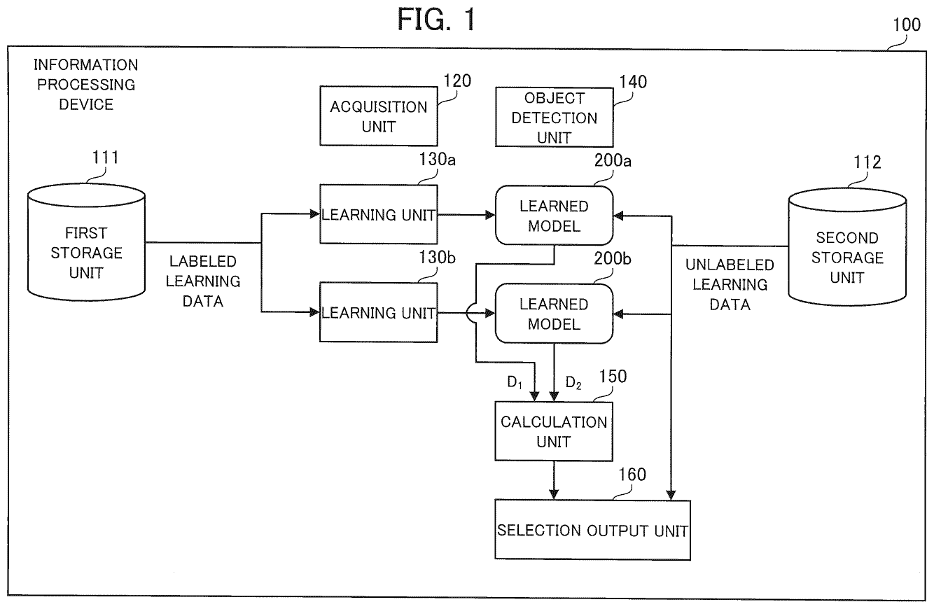

FIG. 1 is a block diagram showing functions of an information processing device in a first embodiment. The information processing device 100 is a device that executes a selection output method. The information processing device 100 includes a first storage unit 111, a second storage unit 112, an acquisition unit 120, learning units 130a and 130b, an object detection unit 140, a calculation unit 150 and a selection output unit 160.

Here, hardware included in the information processing device 100 will be described below.

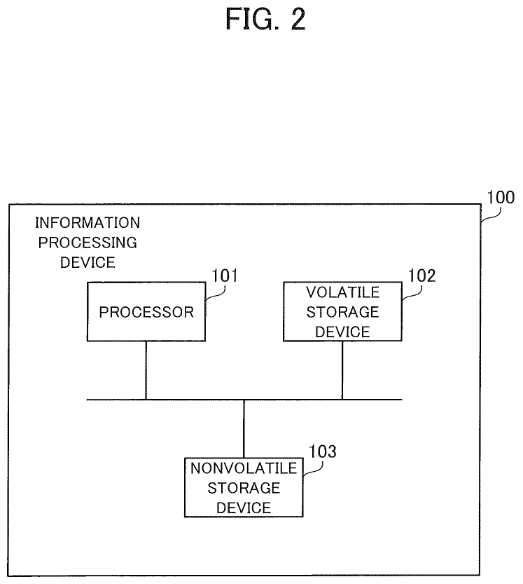

FIG. 2 is a diagram showing the hardware included in the information processing device in the first embodiment. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry. The processing circuitry may be either a single circuit or a combined circuit.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Returning to FIG. 1, the functions of the information processing device 100 will be described below.

The first storage unit 111 and the second storage unit 112 may also be implemented as storage areas reserved in the volatile storage device 102 or the nonvolatile storage device 103.

Part or all of the acquisition unit 120, the learning units 130a and 130b, the object detection unit 140, the calculation unit 150 and the selection output unit 160 may be implemented by the processing circuitry. Further, part or all of the acquisition unit 120, the learning units 130a and 130b, the object detection unit 140, the calculation unit 150 and the selection output unit 160 may be implemented as modules of a program executed by the processor 101. For example, the program executed by the processor 101 is referred to also as a selection output program. The selection output program has been recorded in a record medium, for example.

The information processing device 100 generates learned models 200a and 200b. A process until the learned models 200a and 200b are generated will be described below.

First, the first storage unit 111 will be described. The first storage unit 111 may store labeled learning data. The labeled learning data includes an image, at least one region of an object as a detection target in the image, and a label indicating the type of the object. Incidentally, information including the region of the object and the label is referred to also as label information. When the image is an image including a road, for example, the type is four-wheel vehicle, two-wheel vehicle, truck, or the like.

The acquisition unit 120 acquires the labeled learning data. The acquisition unit 120 acquires the labeled learning data from the first storage unit 111, for example. Alternatively, the acquisition unit 120 acquires the labeled learning data from an external device (e.g., cloud server), for example.

The learning units 130a and 130b generate the learned models 200a and 200b by executing object detection learning in methods different from each other by using the labeled learning data. For example, each of these methods can be Faster Regions with Convolutional Neural Networks (R-CNN), You Look Only Once (YOLO), Single Shot MultiBox Detector (SSD), or the like. Incidentally, each method can be referred to also as algorithm.

As above, by the learning units 130a and 130b, the learned models 200a and 200b for executing object detection by methods different from each other are generated. For example, the learned model 200a is a learned model for executing the object detection by using Faster R-CNN. For example, the learned model 200b is a learned model for executing the object detection by using YOLO.

In this example, two learning units are shown in FIG. 1. The number of learning units is not limited to two. The same number of learned models as the learning units are generated. Thus, the number of learned models is not limited to two. Further, each learned model may be referred to also as a detector or detector information.

The learned models 200a and 200b generated may be stored in the volatile storage device 102 or the nonvolatile storage device 103 or stored in an external device.

Next, a process executed by the information processing device 100 after the generation of the learned models 200a and 200b will be described below.

First, the second storage unit 112 will be described. The second storage unit 112 may store a plurality of pieces of unlabeled learning data. Each of the plurality of pieces of unlabeled learning data does not include the label information. The plurality of pieces of unlabeled learning data are a plurality of images. Each of the plurality of images includes an object. The object is a human, an animal or the like, for example.

The acquisition unit 120 acquires a plurality of pieces of unlabeled learning data. The acquisition unit 120 acquires the plurality of pieces of unlabeled learning data from the second storage unit 112, for example. Alternatively, the acquisition unit 120 acquires the plurality of pieces of unlabeled learning data from an external device, for example.

The acquisition unit 120 acquires the learned models 200a and 200b. The acquisition unit 120 acquires the learned models 200a and 200b from the volatile storage device 102 or the nonvolatile storage device 103, for example. Alternatively, the acquisition unit 120 acquires the learned models 200a and 200b from an external device, for example.

The object detection unit 140 performs the object detection on each of the plurality of pieces of unlabeled learning data by using the learned models 200a and 200b. For example, when the number of pieces of unlabeled learning data is two, the object detection unit 140 performs the object detection on first unlabeled learning data, as one of the plurality of pieces of unlabeled learning data, by using the learned models 200a and 200b. In other words, the object detection unit 140 executes the object detection by using the first unlabeled learning data and the learned models 200a and 200b. Further, for example, the object detection unit 140 performs the object detection on second unlabeled learning data, as one of the plurality of pieces of unlabeled learning data, by using the learned models 200a and 200b.

As above, the object detection unit 140 performs the object detection on each of the plurality of pieces of unlabeled learning data by using the learned models 200a and 200b.

First, a case where the object detection is executed by using one piece of unlabeled learning data and the learned models 200a and 200b will be described below. Further, a method for calculating an information amount score corresponding to the one piece of unlabeled learning data will also be described below.

The object detection unit 140 executes the object detection by using the one piece of unlabeled learning data and the learned models 200a and 200b. The object detection unit 140 executes the object detection by using the unlabeled learning data and the learned model 200a, for example. Further, the object detection unit 140 executes the object detection by using the unlabeled learning data and the learned model 200b, for example. Accordingly, the object detection is executed by methods different from each other. An object detection result is outputted in regard to each learned model. The object detection result is represented as Dᵢ. Incidentally, i is an integer from 1 to N. Further, the object detection result Dᵢ is referred to also as a reasoning label Rᵢ. The reasoning label Ri is expressed as “(c, x, y, w, h)”. The parameter c indicates the type of the object. The parameters x and y indicate coordinates (x, y) of an image region center of the object. The parameter w indicates width of the object. The parameter h indicates height of the object.

The calculation unit 150 calculates the information amount score by using the object detection result Dᵢ. The information amount score indicates value of the unlabeled learning data. Thus, a larger value of the information amount score indicates that the unlabeled learning data has greater value as learning data. In other words, the information amount score varies greatly in the result of the type in an image region having high similarity. Alternatively, the information amount score varies greatly in the image region in the result of the same type.

A method for calculating the information amount score will be described below. In the calculation of the information amount score, mean Average Precision (mAP) @0.5 as a detection accuracy index in consideration of similarity of the image region of each object and difference in the type result of each object is used. Incidentally, “0.5” represents a threshold value of Intersection over Union (IoU) which will be described later.

When there are two learned models, the information amount score is calculated by using expression (1). Here, the object detection result outputted from the learned model 200a is represented as Dᵢ. The object detection result outputted from the learned model 200b is represented as D₂.

INFORMATION AMOUNT SCORE_{N=2}=1−mAP@0.5(D₁,D₂) (1)

Further, the mAP@0.5 is one of evaluation methods in the object detection, and the IoU is known as a concept used for the evaluation. When the object detection has been executed by using labeled learning data, the IoU is represented by using expression (2). The character R_{gt} represents a true value region. The character R_{d} represents a detection region. The character A represents an area.

$$IoU ( {R}_{gt} , {R}_{d} ) = \frac{A ( {R}_{gt} ⋂ {R}_{d} )}{A ( {R}_{gt} ⋃ {R}_{d} )} \qquad ( 2 )$$

A concrete example of the true value region R_{gt} and the detection region R_{d} will be described below.

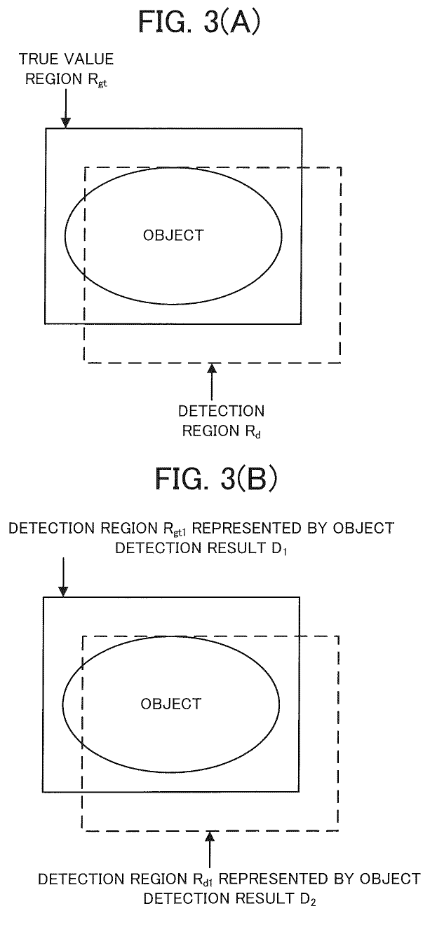

FIGS. 3(A) and 3(B) are diagrams for explaining the IoU in the first embodiment. FIG. 3(A) shows a concrete example of the true value region R_{gt} and the detection region R_{d}. Further, FIG. 3(A) shows how much the true value region R_{gt} and the detection region R_{d} overlap with each other.

Here, the unlabeled learning data includes no label. Thus, there is no true value. Accordingly, the IoU cannot be represented by directly using the expression (2). Therefore, the IoU is represented as follows: A region represented by one object detection result is defined as the true value region. Then, a region represented by another object detection result is defined as the detection region. For example, in FIG. 3(B), a detection region R_{gt1} represented by the object detection result D₁ is defined as the true value region. A detection region R_{d1} represented by the object detection result D₂ is defined as the detection region. When the example of FIG. 3(B) is used, the IoU is represented by using expression (3).

$$IoU ( {R}_{gt 1} , {R}_{d 1} ) = \frac{A ( {R}_{gt 1} ⋂ {R}_{d 1} )}{A ( {R}_{gt 1} ⋃ {R}_{d 1} )} \qquad ( 3 )$$

True Positive (TP), False Positive (FP) and False Negative (FN) are calculated by using the IoU.

Incidentally, when the IoU of the detection region R_{gt1} with respect to the detection region R_{d1} is greater than or equal to a threshold value, the TP indicates that the learned model detected an object existing in the image of the unlabeled learning data. In other words, it indicates that the learned model detected a true value since the detection region R_{d1} and the detection region R_{gt1} are situated substantially at the same position.

When the IoU of the detection region R_{gt1} with respect to the detection region R_{d1} is less than the threshold value, the FP indicates that the learned model detected an object not existing in the image of the unlabeled learning data. In other words, it indicates that the learned model made false detection since the detection region R_{gt1} is situated at a deviated position.

When the IoU of the detection region R_{d1} with respect to the detection region R_{gt1} is less than the threshold value, the FN indicates that the learned model did not detect an object existing in the image of the unlabeled learning data. In other words, it indicates that the learned model did not make the detection since the detection region R_{gt1} is situated at a deviated position.

Further, Precision is represented by using the TP and the FP. Specifically, the Precision is represented by using expression (4). Incidentally, the Precision indicates a ratio of data that are actually positive among data that were estimated to be positive. Incidentally, the Precision is referred to also as a precision ratio.

$$Precision = \frac{TP}{TP + FP} \qquad ( 4 )$$

Recall is represented by using the TP and the FP. Specifically, the Recall is represented by using expression (5). Incidentally, the Recall indicates a ratio of data that were estimated to be positive among data that are actually positive. Incidentally, the Recall is referred to also as a recall ratio.

$$Recall = \frac{TP}{TP + FN} \qquad ( 5 )$$

An example of a relationship among the Precision, the Recall and AP will be shown below.

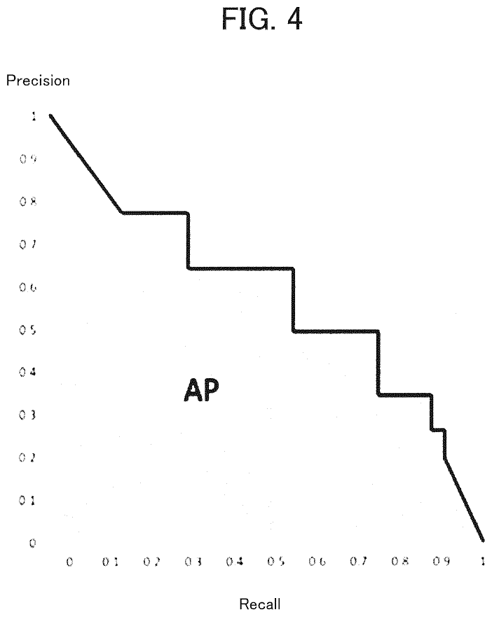

FIG. 4 is a diagram showing the relationship among the Precision, the Recall and the AP in the first embodiment. The vertical axis represents the Precision. The horizontal axis represents the Recall. The Average Precision (AP) is calculated by using the Precision and the Recall. Specifically, the area of “AP” in FIG. 4 is calculated as the AP.

For example, when a plurality of objects exist in the image of the unlabeled learning data, the calculation unit 150 calculates the TP, the FP and the FN of each of the plurality of objects. The calculation unit 150 calculates the Precision and the Recall of each of the plurality of objects by using the expression (4) and the expression (5). The calculation unit 150 calculates the AP of each object (i.e., class) based on the Precision and the Recall of each of the plurality of objects. For example, when the plurality of objects are a cat and a dog, the AP “0.4” of the cat and the AP “0.6” of the dog are calculated. The calculation unit 150 calculates the average of the APs of the objects as the mAP. For example, when the AP of the cat is “0.4” and the AP of the dog is “0.6”, the calculation unit 150 calculates the mAP “0.5”. Incidentally, when only one object exists in the image of the unlabeled learning data, one AP is calculated. Then, the one AP serves as the mAP.

The mAP is calculated as above. The calculation unit 150 calculates the information amount score by using the mAP and the expression (1). Namely, the calculation unit 150 calculates the information amount score by “1−mAP”. The information amount score is calculated as above.

When there are N (i.e., 3 or more) leaned models, the information amount score is calculated by using expression (6). Namely, the calculation unit 150 generates a plurality of combinations of two leaned models by using the N leaned models, calculates a value for each combination by using the expression (1), and calculates the information amount score by dividing the sum total of the calculated values by N.

$$INFORMATION AMOUNT {SCORE}_{N > 2} = \frac{1}{N} {\sum }_{i , j ∈ ( 1 , N ) , i \neq j} ( 1 - mAP @ 0.5 ( {D}_{i} , {D}_{j} ) ) \qquad ( 6 )$$

As above, the calculation unit 150 calculates the information amount score corresponding to the one piece of unlabeled learning data. Then, the information processing device 100 (i.e., the object detection unit 140 and the calculation unit 150) performs the same process also on each of the plurality of pieces of unlabeled learning data. By this, the information processing device 100 is capable of obtaining the information amount score of each of the plurality of pieces of unlabeled learning data. In other words, the information processing device 100 is capable of obtaining a plurality of information amount scores corresponding to the plurality of pieces of unlabeled learning data. As above, the information processing device 100 calculates the plurality of information amount scores based on a plurality of object detection results. Specifically, the information processing device 100 calculates the plurality of information amount scores by using the mAPs and the plurality of object detection results.

The selection output unit 160 selects a predetermined number of pieces of unlabeled learning data from the plurality of pieces of unlabeled learning data based on the plurality of information amount scores. In other words, the selection output unit 160 selects unlabeled learning data having great learning effect from the plurality of pieces of unlabeled learning data corresponding to the plurality of information amount scores based on the plurality of information amount scores. This sentence may also be expressed as follows: The selection output unit 160 selects unlabeled learning data that is/are expected to contribute to the learning from the plurality of pieces of unlabeled learning data.

An example of the method of the selection will be described below. In the first place, the information amount score is a value in a range from 0 to 1. When the information amount score is “0”, the detection results by the learned models 200a and 200b substantially coincide with each other. Therefore, unlabeled learning data corresponding to the information amount score “0” is considered to have low usefulness since the degree of necessity of appropriating the unlabeled learning data for learning data is low. In contrast, when the information amount score is “1”, the detection results by the learned models 200a and 200b greatly differ from each other. However, unlabeled learning data corresponding to the information amount score “1” can be regarded also as a special example that is extremely difficult to detect. Therefore, adding a lot of special examples to the learning data at a stage when the amount of learning data is small is considered not to contribute to improvement in the detection performance. Thus, the selection output unit 160 excludes such unlabeled learning data corresponding to the information amount score “0” or “1” from the plurality of pieces of unlabeled learning data corresponding to the plurality of information amount scores. After the exclusion, the selection output unit 160 selects top n (n is a positive integer) pieces of unlabeled learning data from the plurality of pieces of unlabeled learning data as unlabeled learning data having great learning effect.

The selection output unit 160 outputs the selected unlabeled learning data. It is also possible for the selection output unit 160 to output object detection results, as results of performing the object detection on the selected unlabeled learning data (hereinafter referred to as selected images), as the reasoning labels. Here, examples of the output of the selected images will be described below.

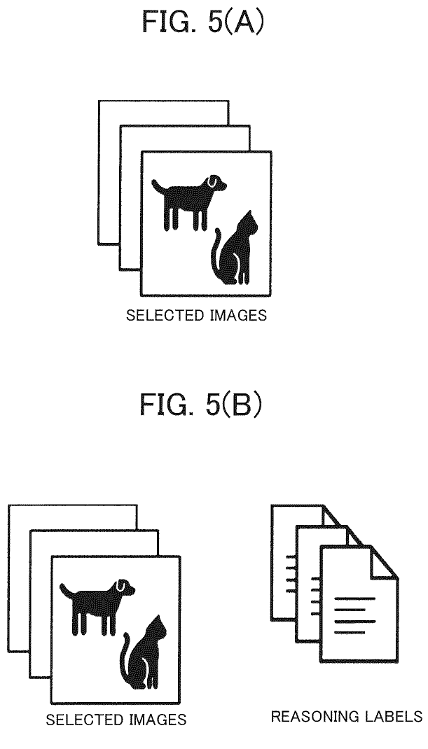

FIGS. 5(A) and 5(B) are diagrams (No. 1) showing examples of the output of the selected images. FIG. 5(A) shows a case where the selected images are outputted to the volatile storage device 102 or the nonvolatile storage device 103. For example, the labeling worker performs the labeling on the selected images by using the information processing device 100.

FIG. 5(B) shows a case where the selected images and the reasoning labels are outputted to the volatile storage device 102 or the nonvolatile storage device 103. For example, the labeling worker performs the labeling on the selected images by using the information processing device 100 and the reasoning labels. Further, by the outputting of the reasoning labels, the labeling workload on the labeling worker is lightened.

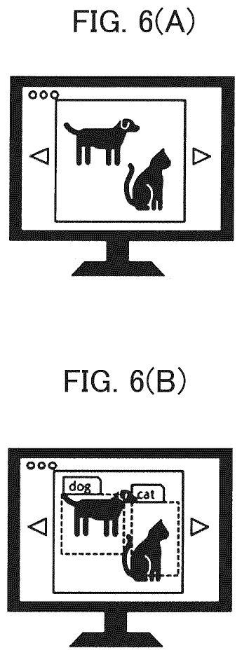

FIGS. 6(A) and 6(B) are diagrams (No. 2) showing examples of the output of the selected images. FIG. 6(A) shows a case where the selected images are outputted to a labeling tool. Since the selected images are outputted to the labeling tool as above, the labeling workload on the labeling worker is lightened.

FIG. 6(B) shows a case where the selected images and the reasoning labels are outputted to the labeling tool. The labeling worker performs the labeling on the selected images while correcting the reasoning labels by using the labeling tool.

Here, the images selected by the selection output unit 160 are images selected by using learned models that detect an object by methods different from each other. Therefore, the selected images are not only suitable as learning data used when executing the learning by a certain method but also suitable as learning data used when executing the learning by a different method. Thus, the selected images can be regarded as learning data having great learning effect. According to the first embodiment, the information processing device 100 is capable of selecting learning data having great learning effect.

Further, the learning data having great learning effect are automatically selected by the information processing device 100. Therefore, the information processing device 100 is capable of efficiently selecting the learning data having great learning effect.

### Second Embodiment

Next, a second embodiment will be described below. In the second embodiment, the description will be given mainly of features different from those in the first embodiment. In the second embodiment, the description is omitted for features in common with the first embodiment.

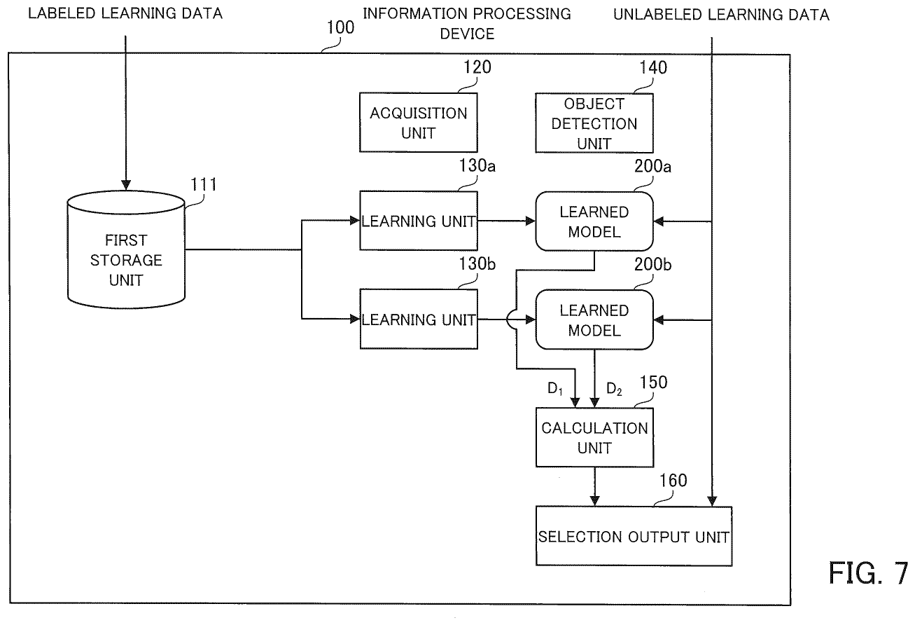

FIG. 7 is a block diagram showing functions of an information processing device in the second embodiment. Each component in FIG. 7 that is the same as a component shown in FIG. 1 is assigned the same reference character as in FIG. 1.

The information processing device 100 relearns the learned models 200a and 200b. Details of the relearning will be described later.

Next, a process executed by the information processing device 100 will be described below by using a flowchart.

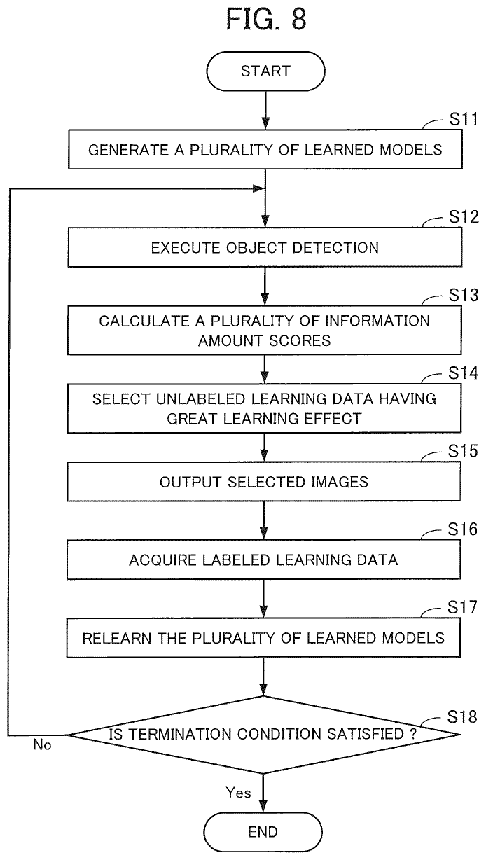

FIG. 8 is a flowchart showing an example of the process executed by the information processing device in the second embodiment.

(Step S11) The acquisition unit 120 acquires the labeled learning data. Incidentally, the data amount of the labeled learning data may be small.

The learning units 130a and 130b generate the learned models 200a and 200b by executing the object detection learning in methods different from each other by using the labeled learning data.

(Step S12) The acquisition unit 120 acquires a plurality of pieces of unlabeled learning data.

The object detection unit 140 executes the object detection by using the plurality of pieces of unlabeled learning data and the learned models 200a and 200b.

(Step S13) The calculation unit 150 calculates a plurality of information amount scores corresponding to the plurality of pieces of unlabeled learning data based on a plurality of object detection results.

(Step S14) The selection output unit 160 selects unlabeled learning data having great learning effect from the plurality of pieces of unlabeled learning data based on the plurality of information amount scores.

(Step ST15) The selection output unit 160 outputs the selected unlabeled learning data (i.e., selected images). For example, the selection output unit 160 outputs the selected images as illustrated in FIG. 5 or FIG. 6.

Here, the labeling worker executes the labeling by using the selected images. By this labeling, labeled learning data is generated. The labeled learning data includes the selected images, at least one region of an object as a detection target in the images, and a label indicating the type of the object. The labeled learning data may be stored in the first storage unit 111. Incidentally, the labeling work may also be executed by an external device.

(Step S16) The acquisition unit 120 acquires the labeled learning data. The acquisition unit 120 acquires the labeled learning data from the first storage unit 111, for example. Alternatively, the acquisition unit 120 acquires the labeled learning data from the external device, for example.

(Step ST7) The learning units 130a and 130b relearn the learned models 200a and 200b by using the labeled learning data.

(Step S18) The information processing device 100 judges whether a termination condition of the learning is satisfied or not. Incidentally, the termination condition has been stored in the nonvolatile storage device 103, for example. When the termination condition is satisfied, the process ends. When the termination condition is not satisfied, the process advances to the step S12.

According to the second embodiment, the information processing device 100 is capable of increasing the object detection accuracy of the learned models by repeating the addition of labeled learning data and the relearning.

Features in the embodiments described above can be appropriately combined with each other.

### DESCRIPTION OF REFERENCE CHARACTERS

100: information processing device, 101: processor, 102: volatile storage device, 103: nonvolatile storage device, 111: first storage unit, 112: second storage unit, 120: acquisition unit, 130a, 130b: learning unit, 140: object detection unit, 150: calculation unit, 160: selection output unit, 200a, 200b learned model.

1. An information processing device comprising:
acquiring circuitry to acquire a plurality of learned models for executing object detection by methods different from each other and a plurality of pieces of unlabeled learning data as a plurality of images including an object;
object detecting circuitry to perform the object detection on each of the plurality of pieces of unlabeled learning data by using the plurality of learned models;
calculating circuitry to calculate a plurality of information amount scores indicating values of the plurality of pieces of unlabeled learning data based on a plurality of object detection results; and
selection outputting circuitry to select a predetermined number of pieces of unlabeled learning data from the plurality of pieces of unlabeled learning data based on the plurality of information amount scores and output the selected unlabeled learning data.

2. The information processing device according to claim 1, wherein the selection outputting circuitry outputs object detection results, as results of performing the object detection on the selected unlabeled learning data, as reasoning labels.

3. The information processing device according to claim 1, wherein the calculating circuitry calculates the plurality of information amount scores by using mean Average Precision and the plurality of object detection results.

4. The information processing device according to claim 1, further comprising a plurality of learning circuitry, wherein
the acquiring circuitry acquires labeled learning data including the selected unlabeled learning data, and
the plurality of learning circuitry relearn the plurality of learned models by using the labeled learning data.

5. A selection output method performed by an information processing device, the selection output method comprising:
acquiring a plurality of learned models for executing object detection by methods different from each other and a plurality of pieces of unlabeled learning data as a plurality of images including an object;
performing the object detection on each of the plurality of pieces of unlabeled learning data by using the plurality of learned models;
calculating a plurality of information amount scores indicating values of the plurality of pieces of unlabeled learning data based on a plurality of object detection results;
selecting a predetermined number of pieces of unlabeled learning data from the plurality of pieces of unlabeled learning data based on the plurality of information amount scores; and
outputting the selected unlabeled learning data.

6. An information processing device comprising:
a processor to execute a program; and
a memory to store the program which, when executed by the processor, performs processes of,
acquiring a plurality of learned models for executing object detection by methods different from each other and a plurality of pieces of unlabeled learning data as a plurality of images including an object;
performing the object detection on each of the plurality of pieces of unlabeled learning data by using the plurality of learned models;
calculating a plurality of information amount scores indicating values of the plurality of pieces of unlabeled learning data based on a plurality of object detection results;
selecting a predetermined number of pieces of unlabeled learning data from the plurality of pieces of unlabeled learning data based on the plurality of information amount scores; and
outputting the selected unlabeled learning data.
